(19) United States
(12) Patent Application Publication
(10) Pub. No.: US 2015/0344308 A1
(43) Pub. Date: Dec. 3, 2015

(54) A high temperature reactor and method of producing nanostructures

(71) Applicant: Nuenz Limited, Christchurch (NZ)

(72) Inventors: Murray Charles McCurdy, Lower Hutt (NZ); Troy Allen Dougherty, Lower Hutt (NZ); Ying Xu, Wellington (NZ); Teck Hock Lim, Kuala Lumpur (NZ)

(73) Assignee: Nuenz Limited, Christchurch (NZ)

(21) Appl. No.: 14/758,241

(22) PCT Filed: Jan. 31, 2014
(86) PCT No.: PCT/NZ2014/000011

§ 371 Date: Jun. 28, 2015

Related U.S. Application Data
(60) Provisional application No. 61/759,289, filed on Jan. 31, 2013.

(51) Int. Cl. C01B 21/068; B01J 8/08; B01J 8/10

(52) U.S. Cl. CPC C01B 21/0685; B01J 8/10; B01J 8/087; B01J 8/085; B01J 2208/00858; B01J 2208/00893

(57) ABSTRACT

A method of producing nanostructures by supplying particulate solid and gaseous reactants to a reactor, heating the reactor to an elevated temperature and causing relative movement of the solid reactants such as to promote the growth of nanostructures. A high temperature reactor for performing the method includes a reactor chamber having an inlet and an outlet, multiple drums for accommodating solid reactant material, a drive system that causes rotation of the drums and a heating system for heating the chamber.

There is also disclosed a method of producing Silicon Nitride nanostructures by supplying solid reactants to a reactor including a carbon source and SiO2, supplying reactant gas to the reactor and maintaining a reactant gas flow rate so as to achieve a desired dwell time and heating the reactor to an elevated temperature.

### FIELD OF THE INVENTION

This invention relates to a high temperature reactor and a method of producing nanostructures. In one aspect the invention relates to a method of producing silicon nitride nanostructures in which relative movement of the solid reactants is induced. In another aspect the invention relates to a method of producing silicon nitride nanostructures in which intermediate gas dwell time is prolonged.

### BACKGROUND OF THE INVENTION

A number of methods and kilns for producing nanostructures (esp. nanofibers) are known. Nanostructures include nanowires, nanofibers, fibers, nanotubes, whiskers and nanowhiskers and in this specification the term “nanostructures” refers to materials having a width of between 20 nanometers and 2 microns and a length of between 5 microns and 10 mm. Conventional wisdom has been to avoid relative movement of solid reactants to avoid damage to or disrupt of the formation of nanostructures. For example U.S. Pat. No. 7,922,871 at paragraph 6, lines 60 to 65 teaches that rotation or tumbling will damage forming fibers. However, the applicant believes that this restricts the exposure of solid reactants to intermediate gasses and inhibits nanostructure formation.

Conventional thinking also suggested that it was best to maximise reactant gas flow rates to maximise nanostructure production. Further, EP1277858 discloses the use of a sweep gas to prevent build up of carbon fibers on the furnace tube. This approach is wasteful of reactant gases which has costs in terms of the amount of reactant gas required and the higher energy costs associated with high flow rates. Further, this approach overlooks the fact that intermediate gasses must dwell near the solid reactants for sufficient time to form nanostructures and too high a flow rate results in the intermediate gasses being flushed from the kiln and inhibits nanostructure formation.

A number of methods and kilns for producing silicon nitride are also known. For example EP0240869 discloses the use of granulated solid reactants in a rotary furnace with high nitrogen gas flow for the production of silicon nitride powder.

Further, U.S. Pat. No. 4,619,905 discloses the use of a pusher furnace with solid reactants in a tray with high nitrogen velocity. Both of these methods inhibit nanostructure formation by using high nitrogen gas flow which sweeps away critical nanostructure-forming intermediate gases. Further, WO2012018264 discloses that silicon nitride nanostructures can be made using a rotary furnace. However, the applicant believes that it is not industrially applicable due to the high cost of building high temperature atmosphere controlled rotary furnaces that are larger than 1 m³.

In this specification references to the terms “high temperature” and “elevated temperature” refer to a temperature range of between 1250° to 1600° C.

A range of static and active high temperature kilns have been used to form nanostructures. Some kilns advance a planar surface through the kiln such as U.S. Pat. No. 5,274,186 that employs rollers to advance sheets or trays and U.S. Pat. No. 4,243,378 that uses balls to support firing plates. Rotary kilns such as US2010/0294700 have also been employed.

Kilns using conveyor plates do not agitate the solid reactants to promote reactions resulting in nanostructure formation. Rotary furnaces for high temperatures require expensive materials that can maintain their strength at high temperatures. Such kilns also offer a limited surface area to support solid reactants and thus provide less exposure to reactant gasses.

It is an object of the invention to provide a high temperature reactor and a method of producing nanostructures that overcomes at least some of these problems or to at least provide the public with a useful choice.

### SUMMARY OF THE INVENTION

According to one exemplary embodiment there is provided a method of producing nanostructures comprising the steps of:
i. supplying particulate solid reactants to a reactor;
ii. supplying reactant gas to the reactor;
iii. heating the reactor to an elevated temperature; and
iv. causing relative movement of the solid reactants such as to promote the growth of nanostructures.

According to another exemplary embodiment there is provided a method of producing Silicon Nitride nanostructures comprising the steps of:
i. supplying solid reactants to a reactor including a carbon source and SiO₂;
ii. supplying reactant gas to the reactor and maintaining a reactant gas flow rate of between 2 to 50 cm/min; and
iii. heating the reactor to an elevated temperature.

According to another exemplary embodiment there is provided a high temperature reactor comprising:
i. a reactor chamber having an inlet and an outlet;
ii. one or more drums for accommodating solid reactant material;
iii. a drive system that causes rotation of the one or more drums; and
iv. a heating system for heating the chamber.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any prior art in this specification does not constitute an admission that such prior art forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of exemplary embodiments given below, serve to explain the principles of the invention.

FIG. 1 shows a diagram of a high temperature reactor in which a plurality of drums are advanced through the reactor;

FIG. 2 shows a drum having smaller diameter rollers that roll along a pair of rails;

FIG. 3 shows an alternative mechanism for advancing drums through a kiln.

### DETAILED DESCRIPTION OF EMBODIMENTS OF THE INVENTION

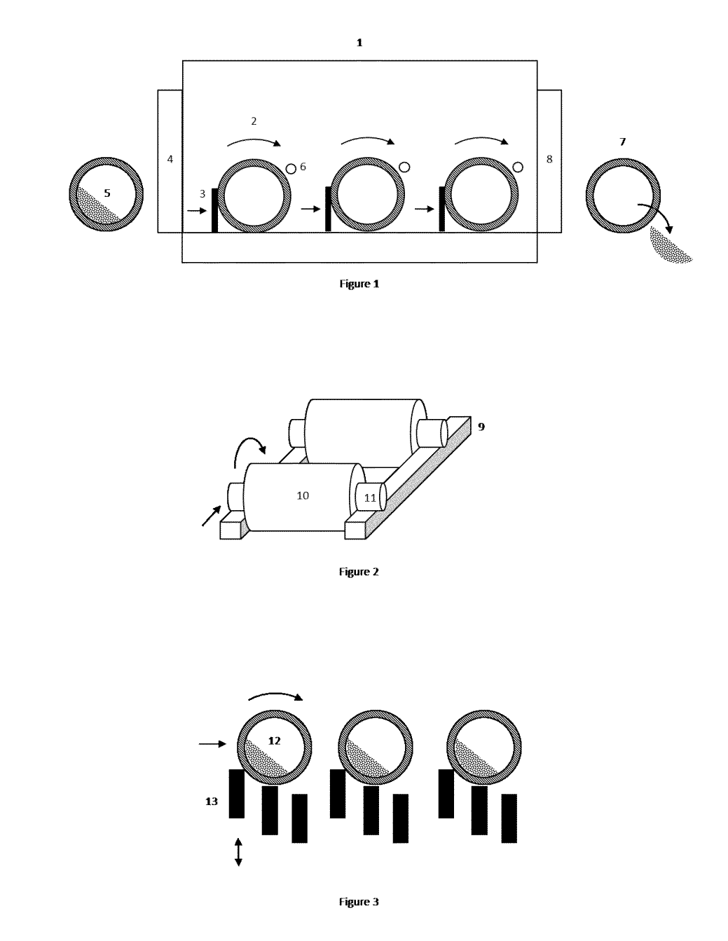

Referring to FIG. 1 a schematic diagram of a high temperature rotary reactor for producing nanostructures is shown. Reactor 1 is a stationary reactor through which are advanced a plurality of drums 2. The reactor 1 may be heated in a conventional manner and formed of suitable insulating material suitable for continuous operation at temperatures of about 1250° C. to 1600° C. Solid reactants 5 are placed within the drums and the drums enter through door 4 and are advanced by pushers 3 which cause the drums 2 to rotate as they advance through the reactor. This design has the advantage that the reactor may be a conventional stationary reactor and so does not need to be formed of materials that can withstand the required temperatures and need not have the strength required to withstand the rotational movement.

For silicon nitride production the solid reactants may be silicon dioxide and a carbon source. Reactant gasses are supplied via inlets 6 on one side and exhaust gasses are removed via outlet on the other side so as to create a gas flow transverse to the direction of drum advancement. For silicon nitride production the gaseous reactants may be nitrogen or ammonia or a mixture of nitrogen and hydrogen.

When a drum 2 reaches the other end it may be removed through door 8 and the solid contents removed 7. The solid material may be removed from the drum and separated into nanofibers and other solid material.

FIG. 2 shows a further embodiment in which a drum 10 has rollers 11 at either end that roll upon rails 9 to produce a greater amount of rotation for a drum as it advances through the reactor.

The drum reactor design allows discrete batching of nanofiber production without mixed products being formed. It also allows multiple drum configurations in a single furnace to deal with different batch properties. Further the components most likely to break (i.e. the drums) can be hot swapped and the Integrity of moving parts can be tested without shutting down the furnace. Further the parts of the furnace in contact with solid reactants (i.e. the drums) are low cost and effectively consumable.

FIG. 3 shows an advantageous mechanism for advancing drums within a kiln of the type shown in FIG. 1. Here pairs of pusher rods 13 may be selectively raised and lowered to advance drum 12 within the kiln. This mechanism is advantageous as the rods may be easily raised and lowered through the floor of the kiln without requiring a complex mechanism within the kiln that must withstand the extreme conditions within the kiln. Linear actuators may drive the rods or a suitable cam arrangement of the like may be employed.

Both the rotational reactor and drum pusher reactor designs cause relative movement of solid reactants. The applicant has found that this movement promotes the production of silicon nitride nanostructures. Whilst not wishing to be bound to any particular theory it is believed that this may be due to one or more of the following:
1. The motion produces clumps of material that better expose the solid reactants to the reactant gasses;
2. The motion produces clumps which also assists in the separation of formed nanostructures from the solid reactants;

In the production of Silicon Nitride a number of intermediate reactions take place forming intermediate gasses. Some of the key reactions are:

SiO₂+C=>SiO+CO

SiO₂+CO=>SiO+CO2

CO₂+C<=>2CO

3SiO₂+6C+2N₂=>Si₃N₄+6CO

3SiO₂+6CO+2N₂=>Si₃N₄+6CO₂

### V-S Reaction:

3SiO(g)+3C(s)+2N₂(g)<->Si₃N₄(s)+3CO(g)

### V-L-S Reaction:

3SiO(g)+3CO(g)+2N₂(g)<->Si₃N₄(s)+3CO₂(g)

At high temperature and in the presence of carbon, carbon dioxide very rapidly becomes carbon monoxide.

Silicon monoxide and carbon monoxide are the key intermediate gasses and excess carbon monoxide needs to be removed as it shifts the V-L-S reaction equilibrium to the left hand side of the equation, which stops the formation of more silicon nitride i.e. remove carbon monoxide and the equilibrium is driven to produce silicon nitride. Desirably the carbon monoxide concentration is preferably kept below 10%.

Conventional thinking has been that high nitrogen flow rates enhance silicon nitride formation. However, as illustrated above there are a number of intermediate gasses that must dwell for a sufficient time to react with the solid reactants. It has been found that a reduced nitrogen supply actually promotes the production of silicon nitride nanostructures using this method. Rather than move the gas stream relative to the solid reactants the solids are moved relative to the gas and the gas flow through the reactor is reduced. This improves heat and mass transfer, reduces energy costs and reduces the cost of reactant gasses.

For silicon nitride production the reactor is preferably maintained at a temperature 1350 to 1450° C. The reactant gas may be nitrogen or ammonia or nitrogen and hydrogen. Where nitrogen and hydrogen are used the hydrogen concentration is preferably less than 20% of the hydrogen/nitrogen mix.

Whilst dependent upon the reactor size a reactant gas velocity of 2 to 50 cm per minute has been found to enhance nanofibers production. More preferably the reactant gas flow rate is between 2 to 30 cm/min and most preferably between 4 to 10 cm/min. The dwell time of the solid reactants in the reactor may be about 4 to 12 hours (more preferably 4 to 6 hours) and the rotational speed at the drum circumference may be about 0.0033 m/s.

There is thus provided a method of producing nanostructures that promotes nanostructure formation, reduces reactant gas usage, reduces energy usage and maintains better temperature regulation due to the lower gas flow rate

There is also provided a high temperature reactor that utilises a robust traditional reactor chamber and replaceable drums that provides a tumbling action without wear and other problems of rotary reactor as well as an enhanced surface area for solid reactants.

While the present invention has been illustrated by the description of the embodiments thereof, and while the embodiments have been described in detail, it is not the intention of the applicant to restrict or in any way limit the scope of the appended claims to such detail. Additional advantages and modifications will readily appear to those skilled in the art. Whilst the invention has been described in relation to silicon nitride it will be appreciated that it could also be applied to the production of, silicon oxynitride and boron nitride and potentially also silicon carbide and boron carbide. Therefore, the invention in its broader aspects is not limited to the specific details, representative apparatus and method, and illustrative examples shown and described. Accordingly, departures may be made from such details without departure from the spirit or scope of the applicant's general inventive concept.

1. A method of producing nanostructures comprising the steps of:
i. supplying particulate solid reactants to a reactor;
ii. supplying reactant gas to the reactor;
iii. heating the reactor to an elevated temperature; and
iv. causing relative movement of the solid reactants such as to promote the growth of nanostructures.

2. A method as claimed in claim 1 wherein the solid reactants are rotated in the reactor.

3. A method as claimed in claim 2 wherein the solid reactants are contained within one or more drum that is rolled within the reactor.

4. A method as claimed in claim 2 wherein the solid reactants are rotated within a rotational reactor.

5. A method of producing Silicon Nitride nanostructures comprising the steps of:
i. supplying solid reactants to a reactor including a carbon source and SiO₂;
ii. supplying reactant gas to the reactor and maintaining a reactant gas flow rate of between 2 to 50 cm/min; and
iii. heating the reactor to an elevated temperature.

6. A method as claimed in claim 5 wherein carbon monoxide concentration is maintained below 10%.

7. A method as claimed in claim 5 or claim 6 wherein the cycle time of the solid reactants through the reactor is 4 to 12 hours.

8. A method as claimed in claim 5 or claim 6 wherein the cycle time of the solid reactants through the reactor is 4 to 6 hours.

9. A method as claimed in any one of claims 5 to 8 wherein the reactant gas flow rate is between 2 to 30 cm/min.

10. A method as claimed in any one of claims 5 to 8 wherein the reactant gas flow rate is between 4 to 10 cm/min.

11. A method as claimed in any one of claims 5 to 10 wherein the reactant gas is Nitrogen or Ammonia.

12. A method as claimed in any one of claims 5 to 10 wherein the reactant gas is Nitrogen and Hydrogen.

13. A method as claimed in claim 12 wherein Hydrogen is less than 20% of the Hydrogen/Nitrogen mix.

14. A method as claimed in any one of claims 5 to 13 wherein the reactor temperature is between 1350° C. to 1450° C.

15. A high temperature reactor comprising:
i. a reactor chamber having an inlet and an outlet;
ii. one or more drums for accommodating solid reactant material;
iii. a drive system that causes rotation of the one or more drums; and
iv. a heating system for heating the chamber.

16. A high temperature reactor as claimed in claim 15 including a reactant gas supply system for supplying reactant gas to the chamber.

17. A high temperature reactor as claimed in claim 15 or claim 16 including a gas removal system for removing gas from the chamber.

18. A high temperature reactor as claimed in any one of claims 15 to 17 wherein the interior surface of each drum has increased interior surface area.

19. A high temperature reactor as claimed in claim 18 wherein the interior surface of each drum has an undulating surface.

20. A high temperature reactor as claimed in claim 18 wherein the interior surface of each drum has formations on its surface.

21. A high temperature reactor as claimed in claim 15 including multiple solid reactant support surfaces within one or more drums.

22. A high temperature reactor as claimed in claim 21 including one or more drum within one or more drum.

23. A high temperature reactor as claimed in any one of claims 15 to 22 wherein the walls of one or more drums are formed of Alumina Silicate or Zirconia.

24. A high temperature reactor as claimed in any one of claims 15 to 23 wherein the one or more drums are rolled through the reactor.

25. A high temperature reactor as claimed in claim 24 wherein each drum has rollers or smaller diameter that the drum and the rollers of each drum roll along rails to advance the drums through the reactor.

26. A high temperature reactor as claimed in claim 25 wherein each drum rotates at about 0.0033 m/s.

27. A high temperature reactor as claimed in claim 25 including a plurality of rods that may be sequentially caused to project through the floor of the kiln to advance the one or more drums through the kiln.

28. A high temperature reactor as claimed in any one of claims 15 to 27 wherein the reactor includes a plurality of drums.

29. A high temperature reactor as claimed in any one of claims 15 to 23 wherein a single drum is rotated about an axis of rotation.
